(19) United States
(12) Patent Application Publication
(10) Pub. No.: US 2018/0275676 A1
(43) Pub. Date: Sep. 27, 2018

(54) Apparatus for Enabling Autonomous Operation of Land Vehicle Convoys using a Robotic, Bio-Inspired Enterprise (ROBBIE)

(71) Applicant: Irvine Sensors Corporation, Costa Mesa, CA (US)

(72) Inventor: James Justice, Huntington Beach, CA (US)

(73) Assignee: Irvine Sensors Corporation, Costa Mesa, CA (US)

(21) Appl. No.: 15/926,111

(22) Filed: Mar. 20, 2018

Related U.S. Application Data
(60) Provisional application No. 62/474,172, filed on Mar. 21, 2017.

(51) Int. Cl. G05D 1/02; G01S 17/89; G01S 7/48; G01S 7/487; G01S 17/58; G01S 17/42

(52) U.S. Cl. CPC G05D 1/0231; G05D 1/0293; G05D 1/0295; G05D 1/0212; G05D 1/0206; G01S 7/4802; G01S 7/4876; G01S 17/58; G01S 17/42; G01S 17/89

(57) ABSTRACT

A system and method for enabling a plurality of vehicles to be operated as a convoy with the lead vehicle driven by a human and one or more subsequent follower vehicles operated autonomously. The capability is enabled by, 1) the use of a 3D Imaging LIDAR that provides high resolution observations of the preceding vehicle and the surrounding area with sufficient fidelity and timeliness to allow the autonomous navigation of the follower vehicle bearing the disclosed invention, and, 2) the use of a 3D Image Exploitation Processing Appliance that, using techniques that emulate how the human visual path processes and exploits imaging data from the eye, detects, classifies, and labels objects within the observed LIDAR field of view, in a manner to enable autonomous navigation of the follower vehicle.

### CROSS-REFERENCE TO RELATED APPLICATIONS

This application claims the benefit of U.S. Provisional Patent Application No. 62/474,172, filed on Mar. 21, 2017, entitled “An Apparatus and Process that Enables Autonomous Operation of Land Vehicle Convoys Using a Robotic, Bio-Inspired Enterprise (ROBBIE)”, pursuant to 35 USC 119, which application is incorporated fully herein by reference. This application is a continuation-in-part of U.S. Utility patent application Ser. No. 15/064,797, filed on Mar. 9, 2016, entitled “3D Active Warning and Recognition Environment (3D AWARE): A Low Size, Weight, and Power (SWaP) LIDAR with Integrated Image Exploitation Processing for Diverse Applications”, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of sensors and processors that enable autonomous land and sea vehicle operations.

More specifically, the invention relates to use of LIDAR systems and associated data processors that provide and process data which enable autonomous navigation of a convoy of vehicles in a leader/follower mode of operation.

2. Brief Description of the Prior Art

Vehicle convoys generally operate with a driver in each vehicle. Each driver, other than the lead driver, observes the preceding vehicle and navigates to follow that vehicle. The lead vehicle in the convoy sets the path to be navigated by all follower vehicles.

What is needed is a capability for each follower vehicle to sense the navigation actions of the preceding vehicle, to sense the characteristics of the path ahead and to autonomously execute actions needed to follow that vehicle in order to eliminate the need for a driver for that vehicle. In this disclosed concept, the lead vehicle is operated by a driver.

### BRIEF SUMMARY OF THE INVENTION

The instant invention (which may be referred to herein as “ROBBIE”) comprises a three dimensional imaging LIDAR placed on each vehicle in a convoy which senses the actions of the preceding vehicle, determines the path conditions that must be navigated and provides processed data outputs to a navigation computer which communicates with and operates the follower vehicle in such a manner as to maintain speed, direction and spacing with the vehicle in the convoy that it is following.

ROBBIE comprises a LIDAR which provides a capability for sensing under day and night conditions and under conditions of degraded visual environments such as rain, smoke, dust or fog. In addition, the LIDAR preferably operates in a completely eye safe manner. The LIDAR data processor of the invention employs cognitive processing techniques that emulate how the human visual path processes and exploits imagery. The processor extends cognitive processing to the three dimensional imagery provided by the LIDAR. The cognitive processor identifies the objects within the action field of the follower vehicle and determines their ranges from the follower vehicle. This information, when combined with the navigation actions of the preceding vehicle, enables the generation of navigation instructions that autonomously guide the follower vehicle to maintain its intended position within the convoy.

In a first aspect of the invention, an apparatus in the form of a 3D Imaging LIDAR sensing system is disclosed that, when placed on each follower vehicle in a multi-vehicle convoy, observes the preceding vehicle and the surrounding terrain as the convoy transverses the path of the first human-driven vehicle in the convoy, and a 3D Image Exploitation Processing Appliance that labels and accurately locates all elements in the observed field of view of the LIDAR and relays that data to an element of the convoy that effects the navigation of each of the follower vehicles.

In a second aspect of the invention, the LIDAR of the invention operates in the Short Wavelength Infrared (SWIR) spectral region which enables it to operate in day/night conditions and under clear and disturbed visual environments.

In a third aspect of the invention , the LIDAR of the invention operates in a fully eye safe mode.

In a fourth aspect of the invention, the 3D Image Exploitation Processing Appliance of the invention includes Graphics Processing Units (GPUs) and Central Processing Units (CPUs) arranged in an architecture to enable massively parallel processing channels to operate simultaneously.

In a fifth aspect of the invention, the 3D Image Exploitation Processing Appliance of the invention emulates how the visual path in humans processes and interprets imagery sequences.

In a sixth aspect of the invention, the 3D Image Exploitation Processing Appliance of the invention exploits spatial processing routines that determine the spatial content of observed objects using Gabor filters or Histograms of Gaussian equivalents.

In a seventh aspect of the invention, the 3D Image Exploitation Processing Appliance of the invention exploits temporal processing routines using Reichardt filters that determine the motion actions of observed objects.

In an eighth aspect of the invention, the 3D Image Exploitation Processing Appliance of the invention exploits color processing routines that determine the color content of observed objects.

In a ninth aspect of the invention, the 3D Image Exploitation Processing Appliance of the invention combines spatial, temporal, and color objects descriptors to determine and label the type of observed object.

In a tenth aspect of the invention, the 3D Image Exploitation Processing Appliance of the invention combines the range-to-object distance of observed objects and associates that range with the object classification.

In an eleventh aspect of the invention, the 3D Image Exploitation Processing Appliance of the invention formats the object classification and associated range-to-object data and transmits the data on observed scene objects to a vehicle-based navigation unit whose purpose is to effect the driving of the follower vehicle along the previous vehicle path.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 illustrates certain principal elements of the ROBBIE concept disclosed herein.

FIG. 2 depicts an exemplar LIDAR system and block diagram of the invention that is placed on each follower vehicle in the convoy and its principal components.

FIG. 3 shows samples of high resolution scenes produced by an engineering development model depicted in FIG. 2.

FIG. 4 shows selected electronic design elements of an exemplar LIDAR of the invention

FIG. 5 shows the cognitive inspired processing architecture incorporated in the invention that operates on the three dimensional data produced by the LIDAR sensor.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

The ROBBIE system of the invention enables vehicles operating in a leader/follower convoy configuration to successfully operate with a minimum of human personnel—in particular with a driver in a single leader vehicle with the other convoy vehicles operating with no human driver.

In order to accomplish this function, several capabilities must exist within each follower vehicle. First, the follower vehicle must have a sensing element that can see the motion of the vehicle in front of it, observe and understand the terrain that the vehicle is traversing, and then translate that data into a path that is autonomously executed by the follower vehicle using its own navigation computer.

In this fashion, convoys of multiple vehicles can be driven with a single driver controlling the lead vehicle. Additional requirements for such convoy operations are, 1) that the sensor system operate day/night and under conditions of degraded visual environments as well as in clear visibility conditions, 2) that the sensor system operates in a fully eye-safe spectral band, and, 3) that the observations and interpretations of the previous vehicle's motion and of the terrain conditions that are being traversed be accomplished with very low latency in order to effect safe and effective navigation by the follower vehicles.

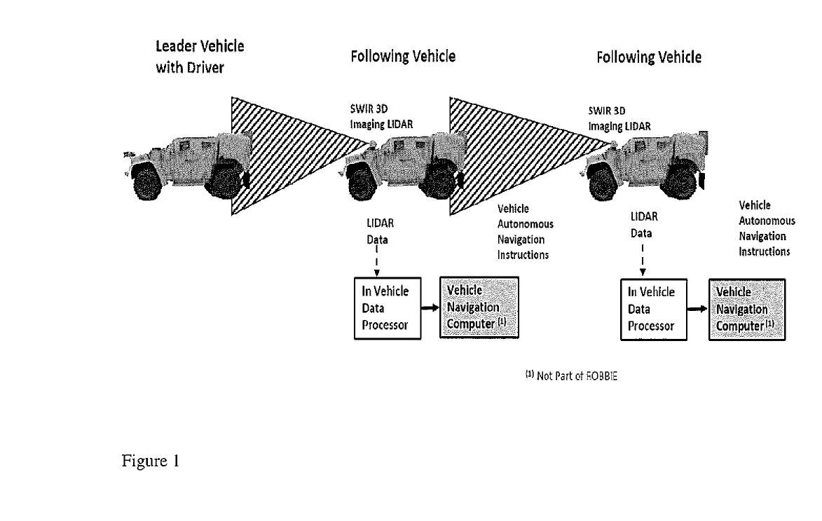

The ROBBIE system herein achieves these capabilities thru a set of specific elements, illustrated in FIG. 1, that when operated together, provide the desired capabilities.

The first key element of ROBBIE is a wide-area search LIDAR. The preferred embodiment operates in the SWIR spectral band near 1.5 microns in wavelength. This band has unique capabilities. First, the atmosphere is more transparent at this band than at other potential LIDAR wavelengths under clear conditions. Second, the atmosphere is more transparent at this wavelength when the atmosphere visibility is degraded by the presence of rain, fog, and dust. The disclosed LIDAR meets the critical requirements of being capable of operating 24/7, under conditions of degraded visibility, and operates with complete human eye safety. Other features of the disclosed LIDAR design are its very high resolution and very high frame rate.

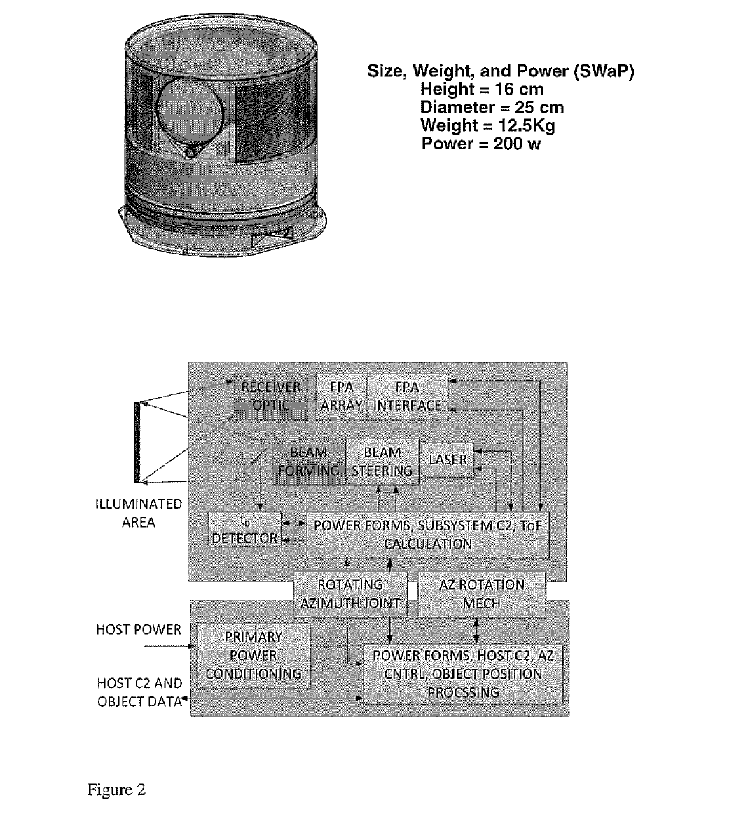

FIG. 2 depicts the design of the LIDAR and exemplar block diagram that is placed on each follower vehicle in the convoy and its principal components.

The operation of the invention requires accurate and timely assessment of scene content including the position and motion behavior of the leader vehicle and each follower vehicle being observed by its follower vehicle. In addition, accurate and timely object detection, classification, and labeling of scene content around each of the vehicles with a LIDAR observing and providing data to the video processor is required.

Inputs to the video analytic processor, which emulate the human visual path processing, consist of two streams of data: a) a communication stream from the lead vehicle of its navigation actions to its follower vehicle, and, b) the labeled, classification content of the scene as observed by the LIDAR on the follower vehicle.

When delivered in real-time to the video processor, these two data streams enable real-time determination of the path the follower vehicle should be executing. The video processor output, when passed to the navigation processor, enables the driving actions for the follower vehicle to be executed, insuring the desired follower vehicle actions.

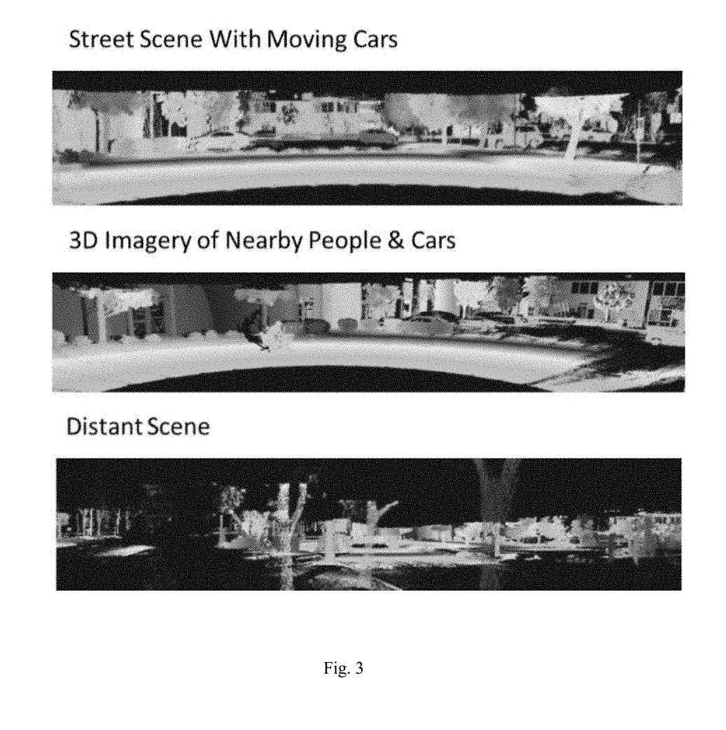

FIG. 3 are examples of three dimensional, high resolution data produced by a ROBBIE engineering development LIDAR which illustrates the ability of the LIDAR to detect and identify salient content of the scenes being observed. The ROBBIE, LIDAR detects and classifies important objects at ranges sufficient to enable autonomous navigation actions and provides sufficient “relooks” at the scene to maintain sufficient data for autonomous navigation as the convoy vehicles are moving at significant convoy speeds.

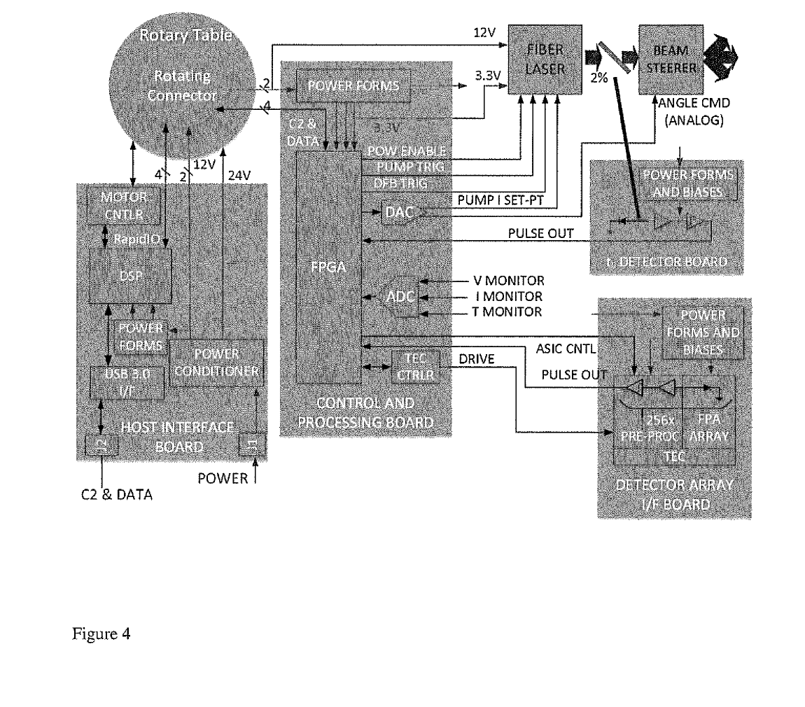

FIG. 4 illustrates a detailed functional block diagram of the ROBBIE LIDAR subsystems. The three dimensional images of objects observed in the scene along the intended path and in regions near it allow accurate object identification along with precise range measurements that together enable successful autonomous navigation under all anticipated conditions of operations.

This produces a high volume of three dimensional image data that must be analyzed with very low latency in order to allow the autonomous navigation function to make timely decisions. This capability requires near real-time analysis of the image content of the three dimensional imagery being produced by the ROBBIE LIDAR. In the ROBBIE invention, this is accomplished by exploiting cognitive processing techniques that emulate how the human visual path processes and interprets image data. These techniques examine the spatial and temporal content and the behavior of scene elements and objects. ROBBIE, image exploitation techniques require massively parallel processing of the imagery which is accomplished by a processing element that is based on integrating Graphics Processing Units (GPUs) with Central Processing Units (CPUs) in an architecture that provides the accuracy and timeliness of the image exploitation function required.

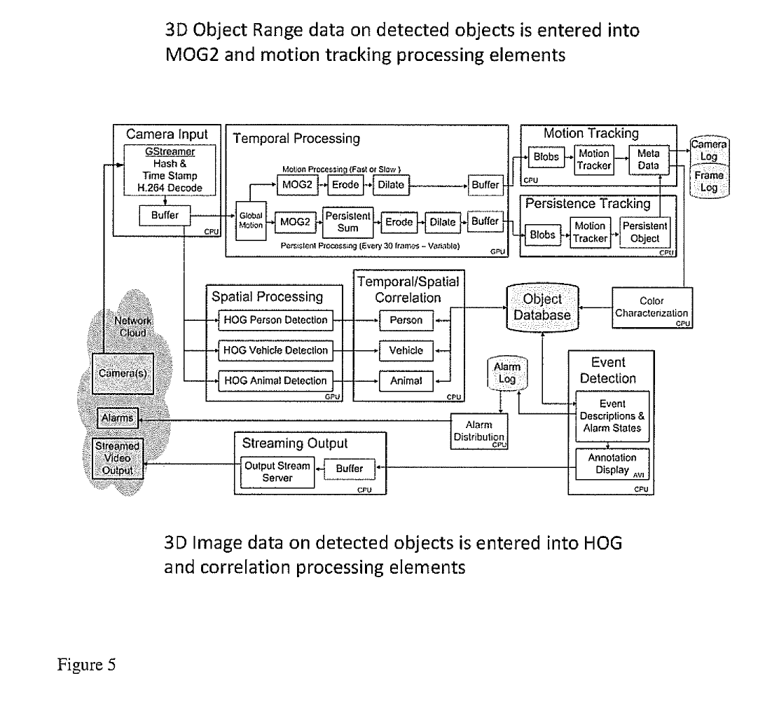

FIG. 5 shows an exemplar cognitive-inspired processing architecture that operates on three dimensional data produced by the LIDAR sensor of the invention.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

What is claimed:

1. An apparatus in the form of a 3D Imaging LIDAR sensing system that, when placed on each follower vehicle in a multi-vehicle convoy, observes the preceding vehicle and the surrounding terrain as the convoy transverses the path of the first human-driven vehicle in the convoy and a 3D Image Exploitation Processing Appliance that labels and accurately locates all elements in the observed field of view of the LIDAR and relays that data to an element of the convoy that effects the navigation of each of the follower vehicles.

2. The LIDAR of claim 1 operates in the Short Wavelength InfraRed (SWIR) spectral region which enables it to operate in day/night conditions and under clear and disturbed visual environments.

3. The LIDAR of Claiml operates in a fully eye safe mode.

4. The 3D Image Exploitation Processing Appliance of claim 1 may include Graphics Processing Units (GPUs) and Central Processing Units (CPUs) arranged in an architecture to enable massively parallel processing channels to operate simultaneously.

5. The 3D Image Exploitation Processing Appliance of claim 1 emulates how the visual path in humans process and interpret imagery sequences.

6. The 3D Image Exploitation Processing Appliance of claim 1 may exploit spatial processing routines that determine the spatial content of observed objects using Gabor filters or Histogram of Gaussian equivalents.

7. The 3D Image Exploitation Processing Appliance of claim 1 may exploit temporal processing routines using Reichardt filters that determine the motion actions of observed objects.

8. Image Exploitation Processing Appliance of claim 1 may exploit color processing routines that determine the color content of observed objects.

9. The 3D Image Exploitation Processing Appliance of claim 1 combines the spatial, temporal, and color objects descriptors to determine and label the type of observed object.

10. The 3D Image Exploitation Processing Appliance of claim 1 combines the range to object distance of observed objects and associates that range with the object classification.

11. The 3D Image Exploitation Processing Appliance of claim 1 formats the object classification and associated range to object data and transmits the data on all observed scene objects to a vehicle-based navigation unit whose purpose is to effect the driving of the follower vehicle along the previous vehicle path.
